(19) United States
(12) Patent Application Publication
(10) Pub. No.: US 2024/0175497 A1
(43) Pub. Date: May 30, 2024

(54) VALVE DEVICE

(71) Applicants: DAIWA KASEI INDUSTRY CO., LTD., Okazaki-shi (JP); KOJIMA INDUSTRIES CORPORATION, Toyota-shi (JP); TOYOTA JIDOSHA KABUSHIKI KAISHA, Toyota-shi (JP)

(72) Inventors: Makoto KATO, Okazaki-shi (JP); Kiyohiro YOSHIHASHI, Okazaki-shi (JP); Junya UKAI, Okazaki-shi (JP); Tomotaka OSAKABE, Toyota-shi (JP); Yusuke TAGUCHI, Toyota-shi (JP); Junki SUGIMOTO, Nisshin-shi (JP); Shigeyuki INOUE, Toyota-shi (JP)

(21) Appl. No.: 18/517,510

(22) Filed: Nov. 22, 2023

(30) Foreign Application Priority Data
Nov. 24, 2022 (JP) 2022-187052

(51) Int. Cl. F16K 1/12; F16K 27/08; F16K 27/12

(52) U.S. Cl. CPC F16K 1/126; F16K 27/08; F16K 27/12; F16K 41/04

(57) ABSTRACT

A valve device includes a cover and a valve. The cover is attached to be fixed to a mating part to which the cover is attached, and includes a cover top part and a leg part extending from an outer peripheral part of the cover top part toward a mating part side to be attached to the mating part at a distal end part in an extending direction, the leg part is one of a plurality of the leg parts that are intermittently disposed in a circumferential direction, and a release hole allowing a release of a fluid from an inside to an outside of the cover is disposed in each space between the leg parts that are adjacent to each other in the circumferential direction.

### CROSS-REFERENCE TO RELATED APPLICATION

The present application claims priority to and incorporates by reference the entire contents of Japanese Patent Application No. 2022-187052 filed in Japan on Nov. 24, 2022.

### BACKGROUND

### 1. Technical Field

The present disclosure relates to a valve device such as a pressure relief valve device for a battery pack that can block an opening formed on a pack case of a battery pack.

### 2. Related Art

As illustrated in FIG. 13, Japanese Patent Application Laid-open No. 2019-96520 discloses a valve device 1 including a cover (housing) 2 and a valve (valve body) 3 that can move in parallel with a direction perpendicular to a surface of a top part 2a of the cover 2 in the cover 2.

However, the technique disclosed in the above application has a problem as described below. A release hole 2b formed on the cover 2 is disposed only on part of the cover 2 in a circumferential direction, so that a direction in which a fluid in the cover 2 is released to the outside of the cover 2 is limited when the valve 3 is in an opened state, and the fluid in the cover 2 is difficult to be released.

To cause the fluid to be easily released and prevent the direction in which the fluid is released from being limited, the release hole 2b is preferably disposed over the entire circumference of the cover 2. However, in this case, it is difficult to dispose, on the cover 2, a guide that can guide the valve 3 over the entire moving range of the valve 3.

### SUMMARY

There is a need for a valve device in which a guide function of a cover for a valve can be secured while a release hole of the cover is disposed over the entire circumference.

In some embodiments, a valve device includes: a cover; and a valve. The cover is attached to be fixed to a mating part to which the cover is attached, and includes a cover top part and a leg part extending from an outer peripheral part of the cover top part toward a mating part side to be attached to the mating part at a distal end part in an extending direction, the leg part is one of a plurality of the leg parts that are intermittently disposed in a circumferential direction, and a release hole allowing a release of a fluid from an inside to an outside of the cover is disposed in each space between the leg parts that are adjacent to each other in the circumferential direction, the valve is movable in parallel with a direction perpendicular to a surface of the cover top part inside the cover with respect to the cover, and a first guide is disposed at an outer peripheral end part of the valve, and a second guide is disposed on an inner surface of the cover at the leg part to control movement of the first guide only in the direction perpendicular to the surface of the cover top part.

The above and other objects, features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is an exploded perspective view of a valve device according to an embodiment of the disclosure;

FIG. 2 is a side view of the valve device according to the embodiment of the disclosure illustrating cross sections of only a valve and a cover when the valve is in a closed position;

FIG. 3 is a side view of the valve device according to the embodiment of the disclosure illustrating cross sections of only the valve and the cover while a spring is not illustrated when the valve is in an opened position;

FIG. 4 is a side view of the valve device according to the embodiment of the disclosure when the valve is in the closed position;

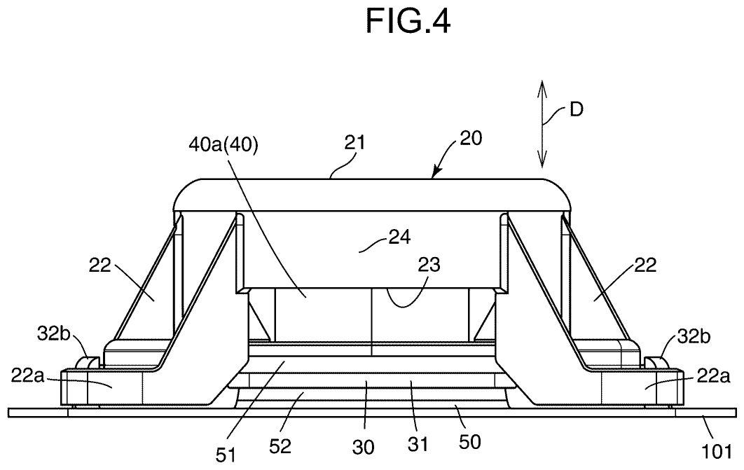

FIG. 5 is a side view of the valve device according to the embodiment of the disclosure when the valve is in the opened position;

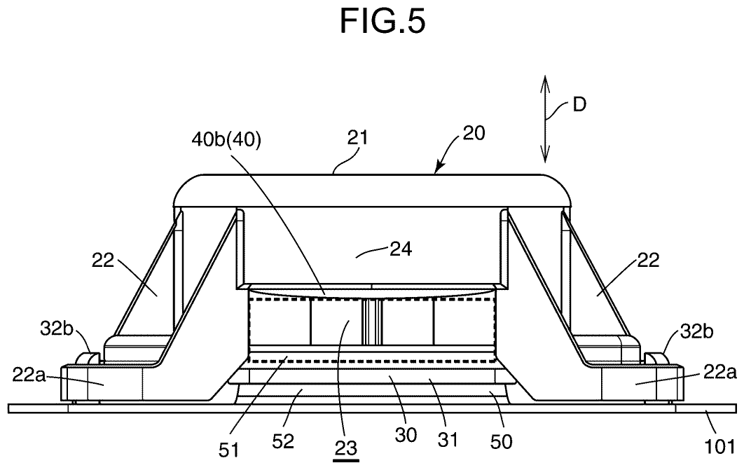

FIG. 6 is a plan view of the valve device according to the embodiment of the disclosure when the valve is in the opened position;

FIG. 7 is a bottom view of the cover of the valve device according to the embodiment of the disclosure;

FIG. 8 is a perspective view of the valve of the valve device according to the embodiment of the disclosure;

FIG. 9 is a side view of the valve of the valve device according to the embodiment of the disclosure;

FIG. 10 is a cross-sectional view of the valve device according to the embodiment of the disclosure while the spring is not illustrated when the valve is in the closed position;

FIG. 11 is an enlarged view of the A part in FIG. 10;

FIG. 12 is a partial cross-sectional view of a sealing part of the valve device according to the embodiment of the disclosure; and

FIG. 13 is a cross-sectional view of a valve device in the related art.

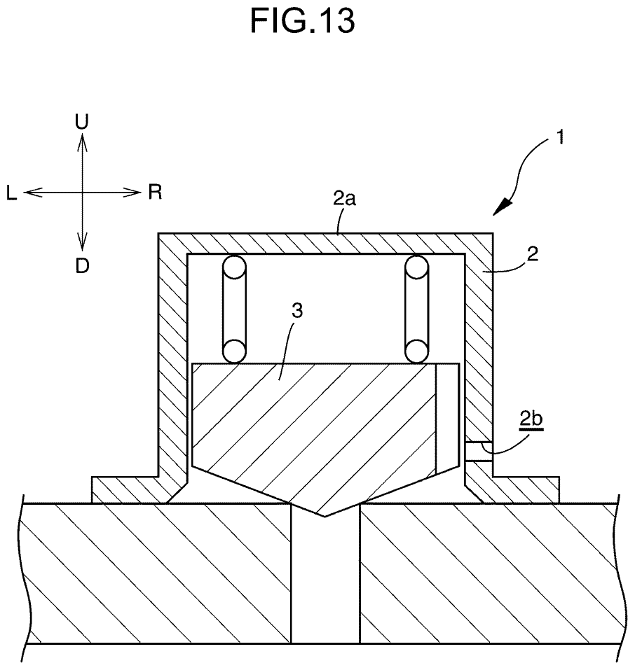

### DETAILED DESCRIPTION

The following describes a valve device 10 according to an embodiment of the disclosure with reference to the drawings.

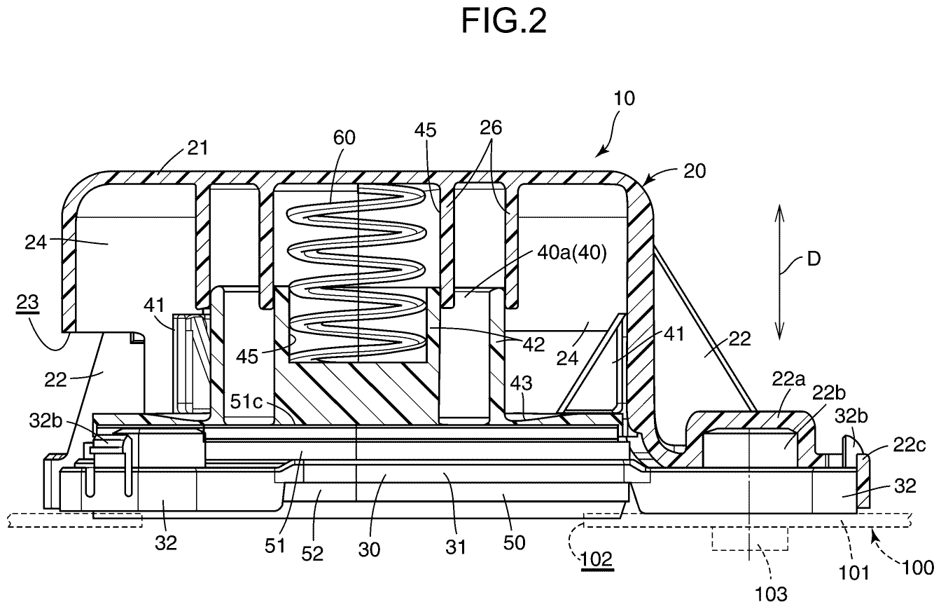

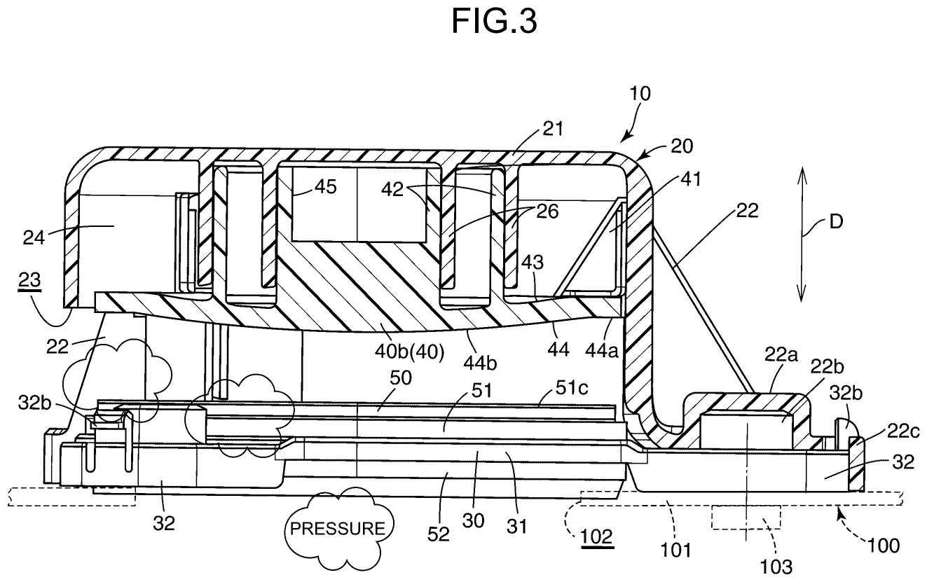

The valve device 10 is not particularly limited, and is a pressure relief valve device for a battery pack that can block an opening 102 formed on a pack case 101 of a battery pack 100 as illustrated in FIG. 2 and FIG. 3, for example. The battery pack 100 is mounted on an electric vehicle (BEV), a hybrid vehicle (HEV), and the like, and houses a plurality of battery cells (not illustrated) inside the pack case 101. The opening 102 formed on the pack case 101 is disposed to prevent a pressure inside the pack case 101 from excessively rising due to discharge of a fluid (gas) from each of the battery cells.

The valve device 10 includes a cover 20, a base 30, a valve 40, a sealing part 50, and a spring 60.

The cover 20 is made of resin, for example, and constituted of one component. The cover 20 is attached to be fixed to the pack case 101 as a mating part to which the cover 20 is attached. The cover 20 includes a cover top part 21 having a flat plate shape (including a substantially flat plate shape), and a leg part 22 extending from an outer peripheral part of the cover top part 21 toward the pack case 101 side to be attached to the pack case 101 at a distal end part in an extending direction.

A plurality of the leg parts 22 are intermittently disposed in the circumferential direction. A release hole 23 through which a fluid is able to be released from the inside of the cover 20 to the outside is disposed in each space between the leg parts 22 that are adjacent to each other in the circumferential direction. The number of the leg parts 22 is not particularly limited so long as the number is two or more, but the number is preferably three for causing a total opening area of the release hole 23 to be large while securing attachment strength of the cover 20 to the pack case 101.

The cover 20 may further include a coupling part 24 that extends in the circumferential direction between the leg parts 22 and couples the adjacent leg parts 22 to each other. The coupling part 24 is disposed for improving the strength and the rigidity of the cover 20. However, the coupling part 24 is not necessarily disposed in a case in which the strength and the rigidity of the cover 20 can be secured without disposing the coupling part 24. The coupling part 24 may also be coupled to an outer peripheral part of the cover top part 21 to improve the strength and the rigidity of the cover 20. In a case in which the coupling part 24 is disposed, the release hole 23 is in a position between the adjacent leg parts 22 excluding the coupling part 24.

The leg part 22 of the cover 20 has a cover fastening part 22a at a distal end part in the extending direction. A collar 22b made of metal on which a female thread is formed is attached to the cover fastening part 22a. The cover 20 is attached to be fixed to the pack case 101 by screwing a fastener (bolt) 103 to the female thread of the collar 22b from an inner side of the pack case 101. Alternatively, the female thread may be formed on a nut (not illustrated) instead of the collar.

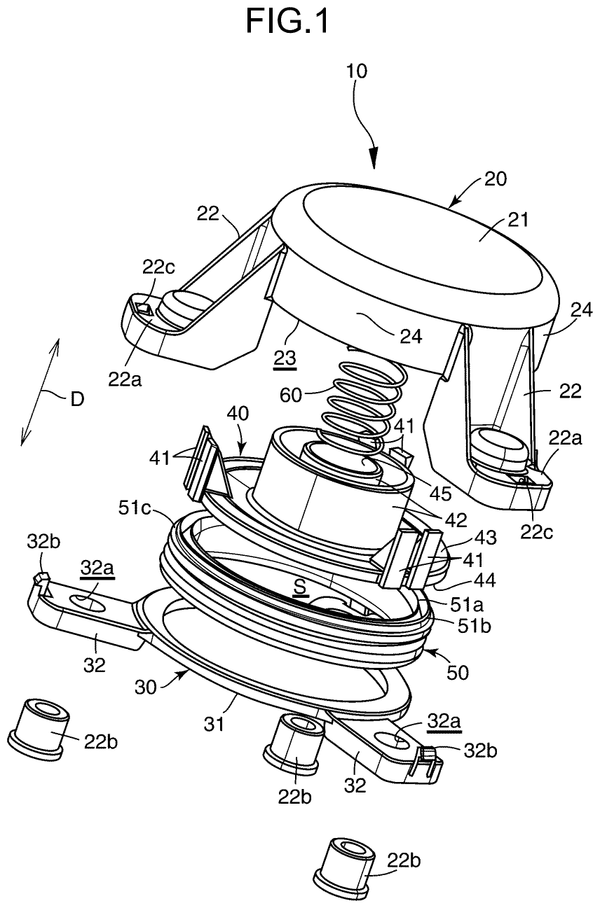

The base 30 is made of resin, for example, and constituted of one component. The base 30 is attached to be fixed to the cover 20. As illustrated in FIG. 1, the base 30 is arranged on the opposite side of the cover top part 21 with respect to the valve 40. The base 30 includes a base ring-shaped part 31 that is continuous over the entire circumference and has an axial core parallel to a direction D perpendicular to a surface of the cover top part 21, and a base fastening part 32 that extends from the base ring-shaped part 31 toward a radially outer side of the base ring-shaped part 31.

The base ring-shaped part 31 may have a circular shape, an elliptic shape, an oval shape, or any polygonal shape having three or more corners in a plan view so long as the ring shape thereof is continuous over the entire circumference. A diameter of the base ring-shaped part 31 is larger than a diameter of the opening 102 formed on the pack case 101.

On the base fastening part 32, disposed are a through hole 32a through which the collar 22b and the fastener 103 can be inserted, and an engaging projection 32b that is elastically deformed and restored to engage with an engagement receiving part 22c formed on the cover fastening part 22a. The cover 20 and the base 30 are co-fastened to the pack case 101 using the fastener 103 in a state in which the cover fastening part 22a and the base fastening part 32 are overlapped with each other, the engaging projection 32b is engaged with the engagement receiving part 22c to temporarily fasten the base 30 to the cover 20, and the collar 22b is inserted through the through hole 32a and the cover fastening part 22a.

The valve 40 is made of resin, for example, and constituted of one component. The valve 40 can move in parallel (including substantially parallel) with the direction D perpendicular to the surface of the cover top part 21 inside the cover 20 with respect to the cover 20. The valve 40 includes a first guide 41, a third guide 42, a cover top part facing surface 43, and a sealing part contact surface 44.

As illustrated in FIG. 2 and FIG. 3, the valve 40 can move in the direction D perpendicular to the surface of the cover top part 21 between a closed position 40a and an opened position 40b, the closed position 40a is a position at which the sealing part contact surface 44 is brought into contact with a one end part 51c in an axial direction of the sealing part 50 to block an inner space S of the sealing part 50, and the opened position 40b is a position at which the sealing part contact surface 44 is separated away from the one end part 51c in the axial direction of the sealing part 50 to open the inner space S of the sealing part 50.

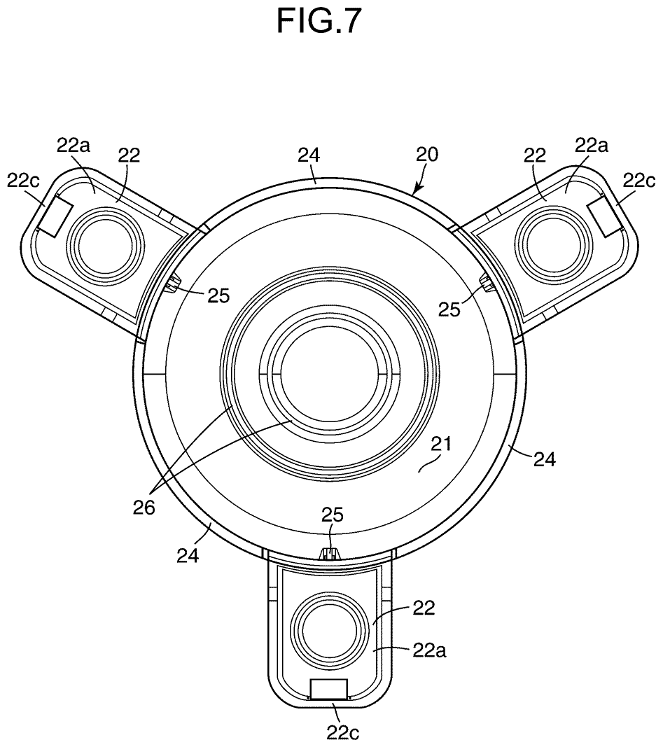

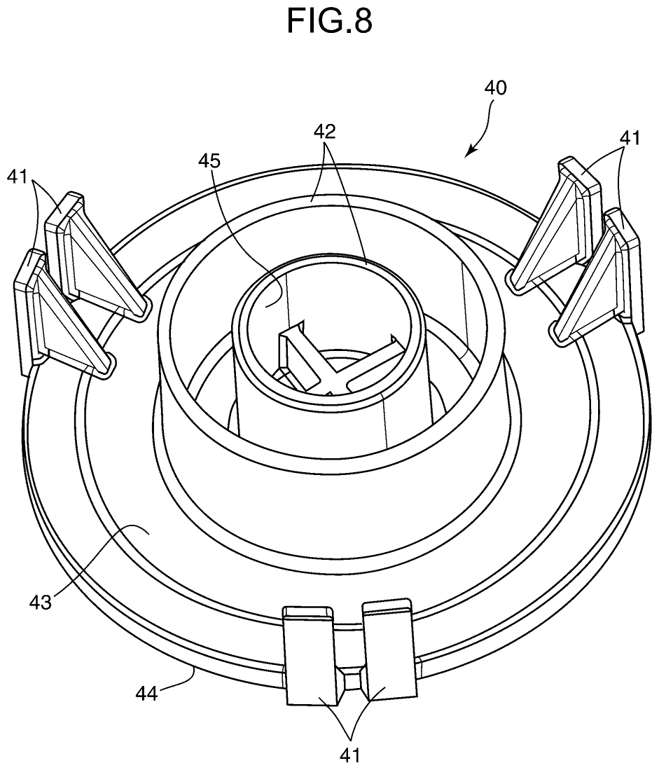

As illustrated in FIG. 8, the first guide 41 is disposed at an outer peripheral end part of the valve 40. The first guide 41 is disposed to extend from an outer peripheral end part of the sealing part contact surface 44 toward the cover top part 21 side (opposite side of the sealing part 50) in the direction D perpendicular to the surface of the cover top part 21. The first guide 41 can move along a second guide 25 disposed on the cover 20. As illustrated in FIG. 7, the second guide 25 is disposed only on an inner surface of the cover 20 at the leg part 22 of the cover 20. The second guide 25 controls movement of the first guide 41 only in the direction D perpendicular to the surface of the cover top part 21.

As illustrated in FIG. 7 and FIG. 8, one of the first guide 41 and the second guide 25 has a rib shape that projects toward the other one of the first guide 41 and the second guide 25 and extends in the direction D perpendicular to the surface of the cover top part 21, and the other one of the first guide 41 and the second guide 25 has a shape of a pair of projections that sandwiches and guides the one of the first guide 41 and the second guide 25. In the example illustrated in the drawing according to the disclosure, the second guide 25 has the rib shape, and the first guide 41 has the shape of a pair of projections.

As illustrated in FIG. 1 to FIG. 3, the third guide 42 has a cylindrical shape, and is disposed to extend toward the cover top part 21 side from the cover top part facing surface 43. The third guide 42 can move along a fourth guide 26 disposed on the cover 20. The fourth guide 26 has a cylindrical shape, and is disposed to extend from the cover top part 21 toward the valve 40 side. The third guide 42 also functions as a reinforcing rib for the valve 40. The fourth guide 26 controls movement of the third guide 42 only in the direction D perpendicular to the surface of the cover top part 21. The number of the third guide 42 is not limited to one, but a plurality of (in the example illustrated in the drawing, two) the third guides 42 may be disposed. In this case, the same number of the fourth guides 26 as the number of the third guides 42 are disposed.

Between the valve 40 and the cover top part 21 of the cover 20, the spring 60 is disposed to energize the valve 40 toward the sealing part 50 side in the direction D perpendicular to the surface of the cover top part 21 with respect to the cover 20. The spring 60 is not particularly limited, and is a compression coil spring, for example. An anticorrosive may be applied or coating and the like may be applied to the spring 60.

On one of the valve 40 and the cover 20, a spring positioning part 45 is disposed to control movement of the spring 60 in a direction orthogonal to the direction D perpendicular to the surface of the cover top part 21. The spring positioning part 45 is disposed on the third guide 42 disposed on the valve 40 or the fourth guide 26 disposed on the cover 20. The spring positioning part 45 is constituted of an inner diameter surface of the third guide 42 or the fourth guide 26. In the example illustrated in the drawing, exemplified is a case in which the spring positioning part 45 is disposed on the valve 40 on which the third guide 42 is disposed, and constituted of the inner diameter surface of the third guide 42. In a case in which a plurality of the third guides 42 and a plurality of the fourth guides 26 are disposed, the spring positioning part 45 is constituted of an inner diameter surface of the guide on the most inner diameter side.

The cover top part facing surface 43 is a surface facing the cover top part 21. The sealing part contact surface 44 is a surface on a back side of the cover top part facing surface 43.

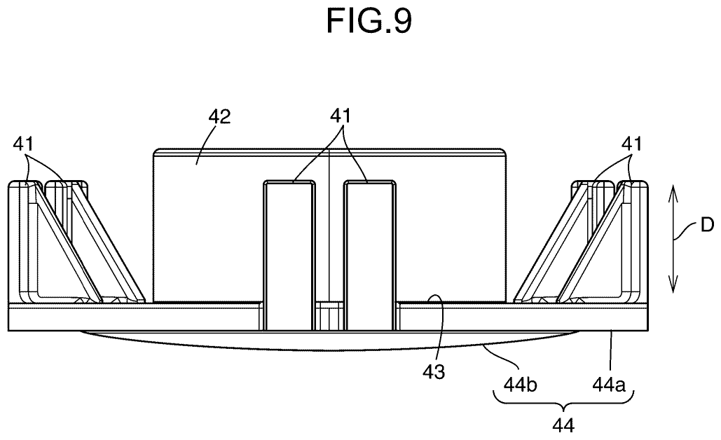

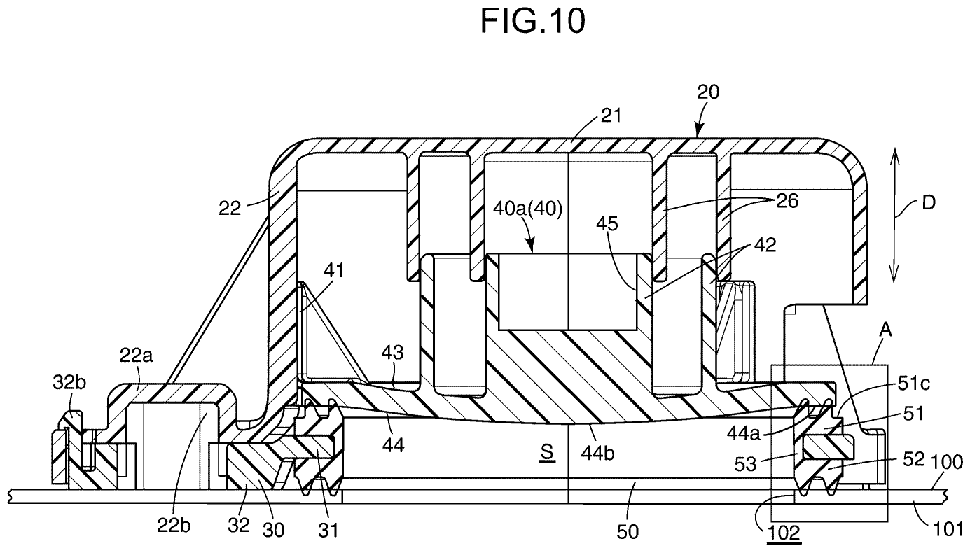

As illustrated in FIG. 9 and FIG. 10, the sealing part contact surface 44 includes a contact surface outer peripheral part 44a that is brought into contact with the one end part 51c in the axial direction of the sealing part 50 when the valve 40 is in the closed position 40a, and a contact surface inner part 44b that is on the inner diameter side with respect to the contact surface outer peripheral part 44a and is not brought into contact with the one end part 51c in the axial direction of the sealing part 50. The contact surface outer peripheral part 44a has a plane shape to secure a sealing property for the sealing part 50. The contact surface inner part 44b has a curved surface the bulging (overhanging) amount of which toward the sealing part 50 is increased toward the inner diameter side (center side) of the contact surface inner part 44b.

The contact surface inner part 44b does not have a V-shape in a cross-sectional view, but has a gently sloping U-shape having a relatively small curvature. This configuration is made to reduce the bulging amount toward the sealing part 50 as compared with a case of the V-shape, and cause the valve 40 (valve device 10) to be compact in the direction D perpendicular to the surface of the cover top part 21.

As illustrated in FIG. 10, the sealing part 50 is made of soft resin such as rubber that can be relatively easily elastically deformed. The sealing part 50 is constituted of one component. The sealing part 50 does not include a hollow part, and is solid. The sealing part 50 is attached to the base 30.

The sealing part 50 has a ring shape that is continuous over the entire circumference and has an axial core agreeing with the axial core of the base ring-shaped part 31, and is attached to the base ring-shaped part 31. Similarly to the base ring-shaped part 31, the sealing part 50 may have a circular shape, an elliptic shape, an oval shape, or any polygonal shape having three or more corners in a plan view so long as the ring shape thereof is continuous over the entire circumference. The diameter (inner diameter) of the sealing part 50 is the same as or larger than the diameter of the opening 102 formed on the pack case 101. An inner space (space on the inner diameter side) S of the sealing part 50 continuously communicates with the inside of the pack case 101 via the opening 102 of the pack case 101.

The sealing part 50 includes a sealing part first portion 51, a sealing part second portion 52, and a sealing part bridging part 53.

The sealing part first portion 51 is a sealing portion on a side of the valve 40 with respect to the base ring-shaped part 31. The one end part 51c in the axial direction of the sealing part 50 is an end part on the valve 40 side of the sealing part first portion 51. The sealing part first portion 51 is sandwiched between the base ring-shaped part 31 and the valve 40 in the direction D perpendicular to the surface of the cover top part 21 (axial direction of the sealing part 50) when the valve 40 is in the closed position 40a.

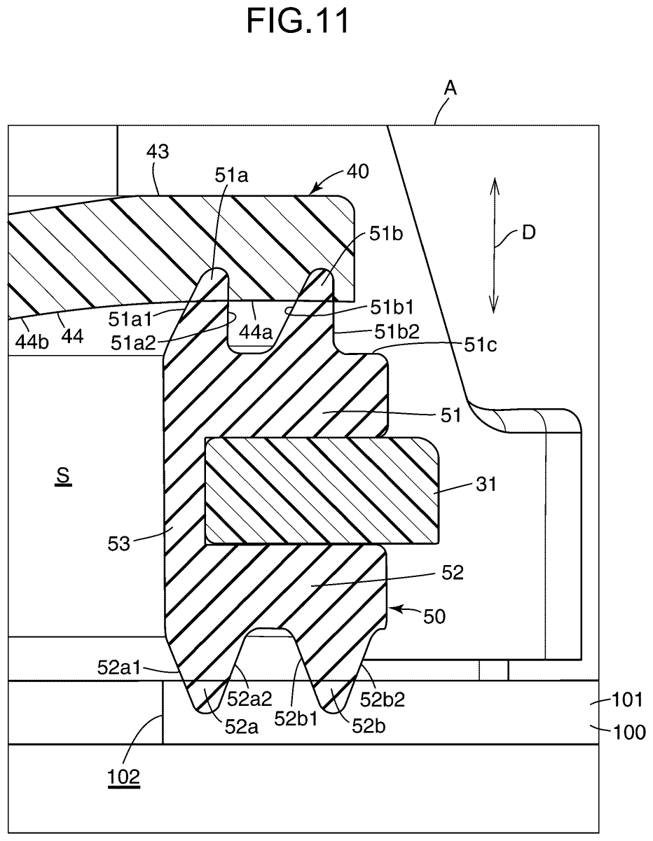

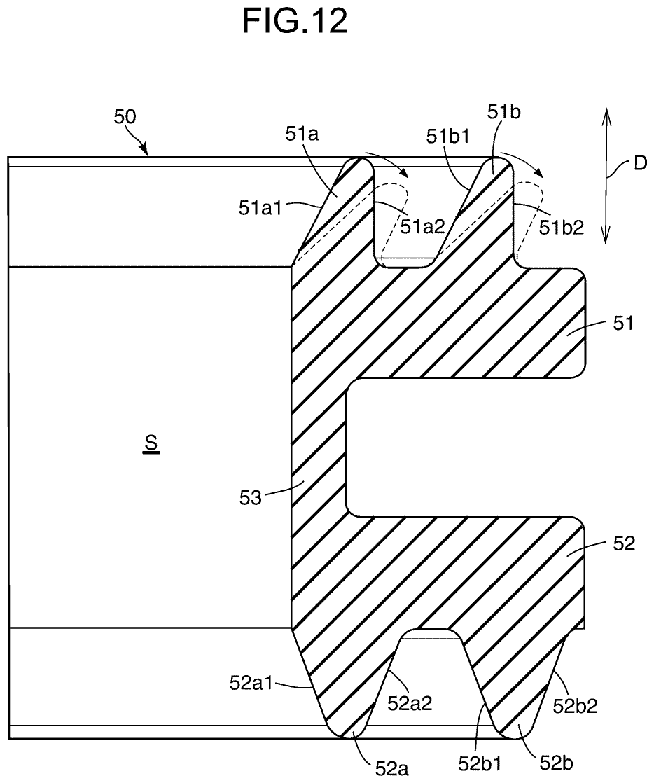

As illustrated in FIG. 11 and FIG. 12, the sealing part first portion 51 includes a first inner projection 51a that projects toward the valve 40 and is continuous over the entire circumference of the sealing part 50, and a first outer projection 51b that is on an outer peripheral side with respect to the first inner projection 51a, projects toward the valve 40 side, and is continuous over the entire circumference of the sealing part 50. Due to this, the sealing part first portion 51 is in surface contact with the base ring-shaped part 31, but in line contact or surface contact with the valve 40 with a smaller contact area as compared with a contact area with the base ring-shaped part 31.

When the first inner projection 51a and the first outer projection 51b are in a free state, with respect to the direction D perpendicular to the surface of the cover top part 21, inclination angles of side surfaces 51a2 and 51b2 on a radially outer side are smaller than those of side surfaces 51al and 51b1 on a radially inner side, respectively, in a lateral cross-sectional view.

The sealing part second portion 52 is a sealing portion on the opposite side of the valve 40 with respect to the base ring-shaped part 31. The sealing part second portion 52 is continuously sandwiched between the base ring-shaped part 31 and the pack case 101 in the direction D perpendicular to the surface of the cover top part 21 (axial direction of the sealing part 50).

The sealing part first portion 51 is on the side of the valve 40 with respect to the base ring-shaped part 31, and the sealing part second portion 52 is on the opposite side of the valve 40 with respect to the base ring-shaped part 31, so that the base ring-shaped part 31 is sandwiched between the sealing part first portion 51 and the sealing part second portion 52.

The sealing part second portion 52 includes a second inner projection 52a that projects toward the pack case 101 and is continuous over the entire circumference of the sealing part 50, and a second outer projection 52b that is on an outer peripheral side with respect to the second inner projection 52a, projects toward the pack case 101, and is continuous over the entire circumference of the sealing part 50. Due to this, the sealing part second portion 52 is in surface contact with the base ring-shaped part 31, but in line contact or surface contact with the pack case 101 with a smaller contact area as compared with the contact area with the base ring-shaped part 31.

When the second inner projection 52a and the second outer projection 52b are in a free state, with respect to the direction D perpendicular to the surface of the cover top part 21, inclination angles of side surfaces 52al and 52b1 on the radially inner side are the same (substantially the same) as inclination angles of side surfaces 52a2 and 52b2 on the radially outer side, respectively, in a lateral cross-sectional view.

The following describes an operation in the embodiment of the disclosure. As illustrated in FIG. 10, when a pressure inside the pack case 101 is smaller than a predetermined value (threshold), the valve 40 is in the closed position 40a. The valve 40 is pressure-welded to the one end part 51c in the axial direction of the sealing part 50 by energizing force of the spring 60 (FIG. 2), and blocks the inner space S of the sealing part 50. Due to this, a fluid in the pack case 101 and the inner space S is prevented from flowing to the outside.

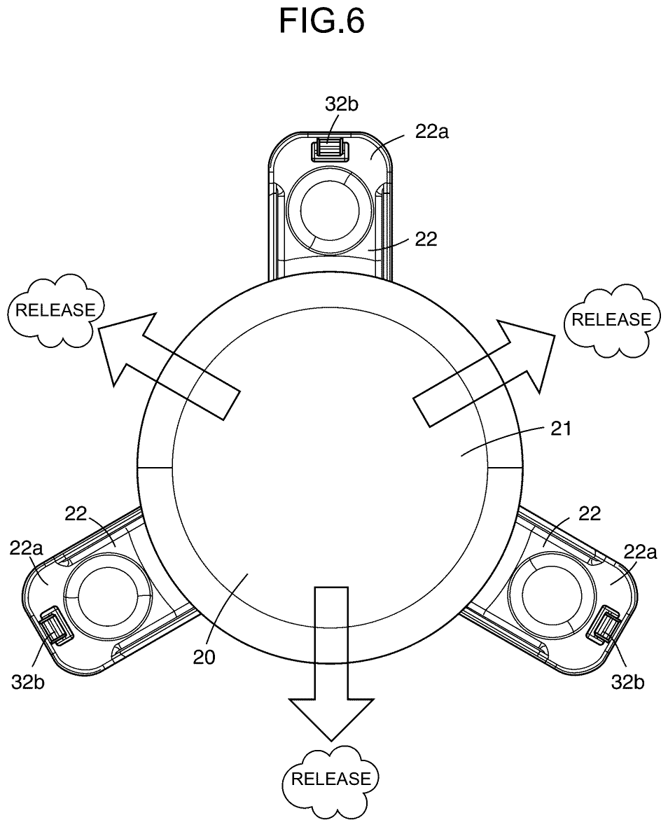

When the pressure inside the pack case 101 becomes equal to or larger than the predetermined value, as illustrated in FIG. 3, the valve 40 is pushed against the energizing force of the spring 60, and moves toward the opened position 40b side. When the valve 40 moves to the opened position 40b side, sealing between the valve 40 and the sealing part 50 is eliminated, and the fluid in the pack case 101 and the inner space S radially flows out over the entire circumference from between the sealing part 50 and the sealing part contact surface 44 of the valve 40. The fluid then passes through the release hole 23 of the cover 20, and radially flows out to the outside of the cover 20 (valve device 10) over the entire circumference (FIG. 6).

Next, the following describes workings and effects of the embodiment of the disclosure.

(A) The release hole 23 through which the fluid can be released from the inside of the cover 20 to the outside is disposed in each space between the leg parts 22 that are adjacent to each other in the circumferential direction, so that the release hole 23 is able to be disposed over the entire circumference excluding the leg parts 22. Additionally, the second guide 25 is disposed only on the inner surface of the cover 20 at the leg part 22 of the cover 20 to control movement of the first guide 41 only in the direction D perpendicular to the surface of the cover top part 21, so that the second guide 25 can be set to be longer as compared with a case of being disposed at a position other than the leg part 22. Thus, the valve 40 can be guided by the second guide 25 over the entire moving range of the valve 40 (entire region of opening and closing), and a guide function for the valve 40 of the cover 20 can be secured.

(B) The valve 40 can move in parallel with the direction D perpendicular to the surface of the cover top part 21 inside the cover 20 with respect to the cover 20, so that the valve 40 can be prevented from limiting a path of the fluid from the inside of the cover 20 to the outside as compared with a case in which the valve 40 does not move in parallel therewith, for example, a case in which the valve 40 is a flap type.

(C) One of the first guide 41 and the second guide 25 has a rib shape that projects toward the other side and extends in the direction D perpendicular to the surface of the cover top part 21, and the other one of the first guide 41 and the second guide 25 has a shape of a pair of projections that sandwiches and guides the one of the first guide 41 and the second guide 25, so that the valve 40 can be relatively smoothly moved when the valve 40 is moved, and the valve 40 can be prevented from rattling with respect to the cover 20.

(D) The sealing part 50 is attached to the base 30 that is attached to be fixed to the cover 20, so that it is not necessary to move both of the valve 40 and the sealing part 50 when the valve 40 is moved, and a weight of a movable part can be reduced.

(E) The cover 20 and the base 30 are co-fastened to the pack case 101 as the mating part using the fastener 103 in a state in which the cover fastening part 22a and the base fastening part 32 are overlapped with each other, so that the number of components and assembly man-hours can be reduced as compared with a case in which the cover 20 and the base 30 are separately attached to the pack case 101 by using different fasteners.

(F) The valve 40 can move between the closed position 40a and the opened position 40b, so that the inner space S of the sealing part 50 can be opened and closed by the valve 40.

(G) The contact surface inner part 44b is a curved surface, the bulging amount of which toward the sealing part 50 side is increased toward the inner diameter side of the contact surface inner part 44b, so that, when the valve 40 moves from the closed position 40a to the opened position 40b and the fluid in the inner space S of the sealing part 50 passes through a space between the sealing part 50 and the valve 40, the fluid can more easily passes therethrough as compared with a case in which the contact surface inner part 44b is a plane or a curved surface, the bulging amount of which toward the sealing part 50 is reduced toward the inner diameter side.

(H) The first guide 41 is disposed to extend from the outer peripheral end part of the sealing part contact surface 44 toward the cover top part 21 side (opposite side of the sealing part 50) in the direction D perpendicular to the surface of the cover top part 21, so that, when the valve 40 moves from the closed position 40a to the opened position 40b and the fluid in the inner space S of the sealing part 50 passes through the space between the sealing part 50 and the valve 40, the first guide 41 can be prevented from hindering flow of the fluid unlike a case in which the first guide 41 is disposed to project from the sealing part contact surface 44 toward the sealing part 50.

(I) Not only the first and the second guides 41 and 25 but also the third and the fourth guides 42 and 26 are disposed, so that movement of the valve 40 with respect to the cover 20 can be securely controlled only in the direction D perpendicular to the surface of the cover top part 21.

(J) The third guide 42 is disposed to extend from the cover top part facing surface 43 toward the cover top part 21 side, so that, when the valve 40 moves from the closed position 40a to the opened position 40b and the fluid in the inner space S of the sealing part 50 passes through the space between the sealing part 50 and the valve 40, the third guide 42 can be prevented from hindering flow of the fluid unlike a case in which the third guide 42 is disposed to project from the sealing part contact surface 44 toward the sealing part 50 side.

(K) The spring 60 is disposed, so that the valve 40 can be moved from the closed position 40a to the opened position 40b only when a differential pressure between the inner space S of the sealing part 50 and the outside of the sealing part 50 reaches a predetermined pressure difference.

(L) The spring positioning part 45 is disposed on the third guide 42 disposed on the valve 40 or on the fourth guide 26 disposed on the cover 20, so that the shape of the valve 40 can be simplified as compared with a case in which the spring positioning part 45 is disposed independently of the third guide 42 or the fourth guide 26.

(M) The sealing part first portion 51 is sandwiched between the base ring-shaped part 31 and the valve 40 when the valve 40 is in the closed position 40a, so that the base 30 and the valve 40 can be continuously sealed by the sealing part first portion 51 over the entire circumference of the sealing part 50.

(N) The sealing part second portion 52 is sandwiched between the base ring-shaped part 31 and the pack case 101 that is the mating part, so that the base 30 and the pack case 101 can be continuously sealed by the sealing part second portion 52 over the entire circumference of the sealing part 50.

(O) The sealing part 50 further includes the sealing part second portion 52 and the sealing part bridging part 53 in addition to the sealing part first portion 51, so that the sealing part 50 constituted of one component can seal not only the base 30 and the valve 40 but also the base 30 and the pack case 101 that is the mating part. Thus, the number of components can be reduced as compared with a case in which the sealing part 50 is constituted of a plurality of components.

(P) The sealing part bridging part 53 passes through the inner diameter side of the base ring-shaped part 31 and couples the sealing part first portion 51 with the sealing part second portion 52, so that a lateral cross-sectional shape of the sealing part 50 becomes a substantially U-shape, and the base ring-shaped part 31 can be sandwiched between the sealing part first portion 51 and the sealing part second portion 52. Thus, the sealing part 50 can be firmly attached to the base 30. Additionally, the sealing part bridging part 53 can be arranged without disposing a through hole on the base ring-shaped part 31, which is advantageous in terms of cost.

(Q) The sealing part first portion 51 includes the first inner projection 51a and the first outer projection 51b, and the sealing part second portion 52 includes the second inner projection 52a and the second outer projection 52b, so that each of the sealing part first portion 51 and the sealing part second portion 52 can be caused to have a double sealing structure, and sealing performance can be improved.

(R) In the first inner projection 51a and the first outer projection 51b, with respect to the axial direction of the sealing part 50 (direction D perpendicular to the surface of the cover top part 21), the inclination angles of the side surfaces 51a2 and 51b2 on the radially outer side are smaller than those of the side surfaces 51a1 and 51b1 on the radially inner side, respectively, in a lateral cross-sectional view. Thus, when the valve 40 is in the opened position 40b and the fluid in the inner space S of the sealing part 50 passes and flows through the space between the valve 40 and the sealing part 50, the first inner projection 51a and the first outer projection 51b easily fall in a fluid flowing direction, and the first inner projection 51a and the first outer projection 51b can be prevented from hindering flow of the fluid.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A valve device comprising:
a cover; and
a valve, wherein
the cover is attached to be fixed to a mating part to which the cover is attached, and includes a cover top part and a leg part extending from an outer peripheral part of the cover top part toward a mating part side to be attached to the mating part at a distal end part in an extending direction,
the leg part is one of a plurality of the leg parts that are intermittently disposed in a circumferential direction, and a release hole allowing a release of a fluid from an inside to an outside of the cover is disposed in each space between the leg parts that are adjacent to each other in the circumferential direction,
the valve is movable in parallel with a direction perpendicular to a surface of the cover top part inside the cover with respect to the cover, and
a first guide is disposed at an outer peripheral end part of the valve, and a second guide is disposed on an inner surface of the cover at the leg part to control movement of the first guide only in the direction perpendicular to the surface of the cover top part.

2. The valve device according to claim 1, wherein one of the first guide and the second guide has a rib shape that projects toward another one of the first guide and the second guide and that extends in the direction perpendicular to the surface of the cover top part, and the other one of the first guide and the second guide has a shape of a pair of projections that sandwiches and guides the one of the first guide and the second guide.

3. The valve device according to claim 1, further comprising:
a base that is attached to be fixed to the cover; and
a sealing part that is attached to the base, wherein
the base includes a base ring-shaped part that is continuous over an entire circumference and has an axial core parallel to the direction perpendicular to the surface of the cover top part, and is arranged on an opposite side of the cover top part with respect to the valve,
the sealing part has a ring shape that is continuous over an entire circumference and that has an axial core agreeing with an axial core of the base ring-shaped part, and
the sealing part is attached to the base ring-shaped part.

4. The valve device according to claim 3, wherein
the leg part of the cover includes a cover fastening part at the distal end part in the extending direction,
the base includes a base fastening part, and
the cover and the base are co-fastened to the mating part using a fastener with the cover fastening part being overlapped with the base fastening part.

5. The valve device according to claim 3, wherein
the valve includes a cover top part facing surface that faces the cover top part and a sealing part contact surface that is on a back side of the cover top part facing surface, and
the valve is movable in the direction perpendicular to the surface of the cover top part between a closed position and an opened position, the closed position being a position at which the sealing part contact surface is brought into contact with a one end part in an axial direction of the sealing part to block an inner space of the sealing part, the opened position being a position at which the sealing part contact surface is separated away from the one end part in the axial direction of the sealing part to open the inner space of the sealing part.

6. The valve device according to claim 5, wherein
the sealing part contact surface includes
a contact surface outer peripheral part that is brought into contact with the one end part in the axial direction of the sealing part when the valve is in the closed position, and
a contact surface inner part that is on an inner diameter side with respect to the contact surface outer peripheral part and that is not brought into contact with the one end part in the axial direction of the sealing part, and
the contact surface inner part has a curved surface, a bulging amount of which toward the sealing part is increased toward the inner diameter side of the contact surface inner part.

7. The valve device according to claim 5, wherein the first guide is disposed to extend from an outer peripheral end part of the sealing part contact surface toward a cover top part side in the direction perpendicular to the surface of the cover top part.

8. The valve device according to claim 5, wherein
the valve includes a third guide that extends from the cover top part facing surface toward a cover top part side, and
the cover includes a fourth guide configured to control movement of the third guide only in the direction perpendicular to the surface of the cover top part.

9. The valve device according to claim 8, wherein
a spring is disposed between the valve and the cover to energize the valve toward the sealing part in the direction perpendicular to the surface of the cover top part with respect to the cover, and
a spring positioning part is disposed on the third guide of the valve or on the fourth guide of the cover to control movement of the spring in a direction orthogonal to the direction perpendicular to the surface of the cover top part.

10. The valve device according to claim 5, wherein
the sealing part includes a sealing part first portion that is on a valve side with respect to the base ring-shaped part, and the one end part in the axial direction of the sealing part is disposed on the sealing part first portion, and
the sealing part first portion is sandwiched between the base ring-shaped part and the valve when the valve is in the closed position.

11. The valve device according to claim 10, wherein
the sealing part further includes
a sealing part second portion that is on an opposite side of the valve with respect to the base ring-shaped part, and
a sealing part bridging part that couples the sealing part first portion with the sealing part second portion, and
the sealing part second portion is sandwiched between the base ring-shaped part and the mating part.

12. The valve device according to claim 11, wherein the sealing part bridging part passes through an inner diameter side of the base ring-shaped part and couples the sealing part first portion with the sealing part second portion.

13. The valve device according to claim 11, wherein
the sealing part first portion includes
a first inner projection that projects toward the valve and that is continuous over the entire circumference of the sealing part, and
a first outer projection that is on an outer peripheral side with respect to the first inner projection, that projects toward the valve, and that is continuous over the entire circumference of the sealing part, and
the sealing part second portion includes
a second inner projection that projects toward the opposite side of the valve and that is continuous over the entire circumference of the sealing part, and
a second outer projection that is on the outer peripheral side with respect to the second inner projection, that projects toward the opposite side of the valve, and that is continuous over the entire circumference of the sealing part.

14. The valve device according to claim 13, wherein,
in a lateral cross-sectional view, each of the first inner projection and the first outer projection has a first side surface that is a side surface on a radially outer side and a second side surface that is a side surface on a radially inner side, and an inclination angle between the first side surface and the direction perpendicular to the surface of the cover top part is smaller than an inclination angle between the second side surface and the direction perpendicular to the surface of the cover top part.

15. The valve device according to claim 1, wherein
the valve device is a pressure relief valve device for a battery pack,
the pressure relief valve device is configured to be attached to a pack case of the battery pack to block an opening formed on the pack case, and
the mating part is the pack case.
